(19) United States
(12) Patent Application Publication
(10) Pub. No.: US 2018/0018606 A1
(43) Pub. Date: Jan. 18, 2018

(54) Method and Apparatus for Operating an Object Lending Network

(71) Applicant: SymbiAutic, Corp., Saratoga Springs, UT (US)

(72) Inventor: Jason William Love, Saratoga Springs, UT (US)

(73) Assignee: SymbiAutic, Corp., Saratoga Springs, UT (US)

(21) Appl. No.: 15/650,853

(22) Filed: Jul. 15, 2017

Related U.S. Application Data
(60) Provisional application No. 62/363,252, filed on Jul. 16, 2016.

(51) Int. Cl. G06Q 10/06; G06Q 10/10; G06Q 10/02; H04L 29/08; H04L 12/16

(52) U.S. Cl. CPC G06Q 10/06315; H04L 67/1078; H04L 12/16; G06Q 10/02; G06Q 10/06312; G06Q 10/1091

(57) ABSTRACT

A peer-to-peer management device for managing the exchange of a selected item in a peer-to-peer exchange includes a processor communicatively connected to memory, a network interface, a non-transitory storage medium. The non-transitory storage medium may include a search receive module, a list creator module, a list sender module, a selection receive module, a personal identification token generator module, a confirmation sender module, a confirmation receiver module, a tracker module, and a return receiver module. The system may receive a) an identification token that has been entered by a first user on a second device and b) an identification token that has been entered by a second user on a first device.

### BACKGROUND

Individuals have sold used items at garage sales or on newer platforms such as eBay®. Using newer platforms, such as eBay® often involve shipping costs. Often times individuals want to borrow an item from a neighbor, but the item may only be available at a rental agency, such as a tool rental agency. The rental agency purchases a number of commonly used tools and rents them to individuals for short term use. Some rental agencies may wish to expand the number of times they lend tools.

One common item that individuals often borrow are tools. Tasks often involve special tools to be performed successfully. An individual seeking to use a tool may purchase or rent a tool to perform a task. When an individual purchases a tool, the tool may be used for the task and then stored until there is a future need. The individual who purchased the tool may loan it to friends, and an individual may wish to borrow tools from others. An owner of a tool may wish to lend out their tools for a price, but the cost of negotiating a price, finding trustworthy borrowers, and other factors may be barriers to increasing the number of tool transactions between a lender and a borrower. Loaning a tool, especially an expensive tool, has inherent risks. A borrower of a tool may not return the tool, or the borrower may return the tool in a damaged condition. Lending a tool to a stranger also has risks, given that the stranger may not return the tool.

As of Jul. 15, 2017, current systems for exchanging items may be described in some detail such as at the websites: us.zilok.com/, http://peerby.com, and http://neighborgoods.net/; however, such systems still have unsolved problems.

### SUMMARY

According to one example, a system for operating an item lending network, such as a tool lending network, may receive data describing a first user and the first user's preferences. For purposes of this disclosure an item lending network may also be referred to as an object lending network. The system may provide information about a number of items, such as tools, that are available for checkout based on the data describing the first user and the first user's preferences. The system may receive information from a first user about a selected item, such as a tool, that the first user desires to check out. The system may identify and notify the users of tool checkout data that describes a place and time the tool is to be exchanged, and the system may notify the prospective tool lender. The system may provide a lender and a borrower with a token that may be used to authenticate each other at the time of a transaction. Payment for borrowing the tool and referral rewards may be facilitated by the system, and the system may set aside a portion of a transaction payment into an escrow account to compensate lenders for tool depreciation.

### BRIEF DESCRIPTION OF THE SEVERAL VIEWS OF THE DRAWINGS

FIG. 1 is an item lending system operating an item exchange network, according to an example of the principles described herein.

FIG. 2 is an item lending system, according to an example of the principles described herein.

FIG. 3 is a flow chart of activity in an item exchange network, according to another example of the principles described herein.

FIG. 4 is a method for operating an item exchange network, according to an example of the principles described herein.

FIG. 5 is a method for operating an item exchange network, according to an example of the principles described herein.

FIG. 6 is a block diagram of a system including a computer program product for operating an item exchange network, according to an example of the principles described herein.

FIG. 7 is a diagram of a device for managing the exchange of a selected item in a peer-to-peer exchange, according to one example of the principles described herein.

FIG. 8A is a method for operating a peer-to-peer exchange network, according to an example of the principles described herein.

FIG. 8B is a continuation of the method in FIG. 8A for a method for operating a peer-to-peer exchange network, according to an example of the principles described herein.

FIG. 9 is a method for operating a peer-to-peer exchange network, according to an example of the principles described herein.

FIG. 10 is a diagram of a device for managing the exchange of a selected item in a peer-to-peer exchange, according to one example of the principles described herein.

FIGS. 11A through 11K are examples of an interface for interacting with the peer-to-peer exchange device, according to one example of the principles described herein.

### DETAILED DESCRIPTION

This disclosure contemplates the lending of items, such as hand tools, books, clothes, vehicles, or the exchange of a service, such as mowing someone's lawn, for another service or payment. Some of the disclosed embodiments are directed at a temporary item exchange between an item owner and an item borrower. For purposes of this disclosure, an item is a a) physical object that may be loaned or purchased online or at a store orb) a service, such as washing someone's dog. Tasks often involve special items to perform the tasks successfully. An individual may purchase or rent an item to perform a task. An individual may desire an item that may perform a task efficiently or precisely. An individual may purchase an item and only use it one time. When an individual purchases an item, a financial commitment is often made to possess the item. The item may be used once or even a couple of times but then may sit idle for expensive periods of time. An individual purchaser may desire to receive benefit from the item. Additionally, a user may not possess an item that is appropriate for a task that the user desires to complete. A user may rent an item from an item center, which may include the hidden cost of time, fuel, and wear and tear on a vehicle while driving to an item center. A user may not know which acquaintances possess the item and may not know which acquaintances are willing to lend the item; some users may spend time asking acquaintances if they possess the item and may also spend time trying to determine whether the acquaintance is willing to lend the item, the condition of the item, and an appropriate fee. Users may be taking a risk from paying a lesser known acquaintance to lend an item because the item may not be in optimal working condition. Likewise, potential lenders often take a risk lending an item because in some circumstances, the borrower may never return the item or may even return the item but in damaged condition. As stated above, the nature of lending and borrowing items from acquaintances may provide some awkwardness to the parties involved. There exists a need for a more efficient way of lending and borrowing useful objects between acquaintances.

An item lending system operating an item lending network provides a framework for an alternative way of gaining access to items. An item lending system allows for peer-to-peer transactions to allow both the owner of the item and a user of an item to benefit. An item owner may receive benefit from owning an item, while an item user may be able to use an item with greater convenience or decreased cost.

An item owner may have an item that is not in use or has an opportunity cost associated with being underutilized. The item owner registers the item with the item lending system. The item lending system may manage compensation for lending the item, including the creation of an escrow account. The item lending system may use an algorithm that uses various variables to determine the fair amount of compensation for a lender who lends one of their items to a borrower via the system; the algorithm may take into account the depreciation of the item as well as referral fees for lenders or borrowers who introduce new users who become lenders or borrowers. The item owner may use the compensation for personal benefit, item repair or replacement, or to expand the item owner's collection. In some embodiments the system may suggest to lenders which items are often-requested by potential borrowers, which may be used by lenders or potential lenders to acquire additional items and meet the market demand.

An item borrower may search an item lending system inventory to identify an item to borrow. The search may include features such as category, keyword, cost or location. In the preferred embodiments, after the borrower identifies an item for which a record has been stored in a database of the system which indicates that the associated item is available to be borrowed. The item lending system may send an item exchange request to the item owner to verify availability of the item and to schedule an item exchange. When the request is accepted, an item return may be scheduled between communication by the parties that is sent through item lending system. In some embodiments, the item lending system includes software that is installed on an item lending module of a remote server and communicates with a user's smartphone. Users may install smartphone apps and the apps may then interact with item return modules, item lending modules or other modules of the item lending system. The item return may then be conducted at the designated time at the designated location using a multi-step process to ensure the transaction occurs safely and securely.

The item lending system may protect personal information in some embodiments by allowing a lender to communicate via the item lending system to a potential user while providing a platform for user feedback and reviews of item lenders and item borrowers.

Although some of the embodiments are directed towards an item exchange, some embodiments may be used with the exchange of other types of objects or even services such as: a professional mentoring, exchange of educational knowledge, or tutoring services; ATV or other type of recreational vehicle exchange; lending of culinary kitchen equipment; cleaning services for residences or condominiums; rental of formal gowns, formal wear, or wedding dresses; and, rental of heavy equipment.

A computer implemented method for operating an item lending network may receive first user data, the first user data identifying attributes of a first user. The method may provide a number of items based on item selection data; the item selection data may include a first user's identification data, and the first user's identification data may be used to identify the first user.

As used in the present specification and in the appended claims, the term “a number of” or similar language may include any positive number including one to infinity; zero not being a number, but the absence of a number.

As used in the present specification and in the appended claims, the term “tool” or similar language means a device or implement used to perform a particular function. A tool may be a hand tool, such as a drill or a hammer, or a heavy piece of equipment. A tool may be a piece of equipment used to perform a specific task.

As used in the present specification and in the appended claims, the term “user” refers to a user of the system. A user may be a human using the system. A user may represent a human representing a business using the system.

As used in the present specification and in the appended claims, the term “data” represents a number of quantities, characters, or symbols representing real world data in a computer environment that are stored on a non-transitory storage device.

As used in the present specification and in the appended claims, the term “checkout” refers to the act of a first user receiving an item from a second user, the second user having primary possession or ownership of the item.

As used in the present specification and in the appended claims, the term “exchange” refers to the act of giving a thing from one individual to another. An exchange may transfer physical possession of an article for a limited period of time, or in other circumstances, an exchange may result in actual transfer of ownership of an article. An exchange may transfer money or credit from one individual to another.

In the following description, for purposes of explanation, numerous specific details are set forth in order to provide a thorough understanding of the present system and methods. It will be apparent, however, to one skilled in the art, that the present apparatus, system, and methods may be practiced without these specified details. Reference in the specification to “an example”, “in a preferred embodiment”, “illustrative”, or similar language means that a particular feature, structure, or characteristic described in connection with that example is included as described, but may not be included in other examples.

References to “peer-to-peer” include an “individual-to-business”, “individual-to-individual”, and “business-to-business”. For example, a first person may want to borrow a lawn mower from their neighbor by using the peer-to-peer management device. The neighbor may have a formal legal entity through which the neighbor lends out tools; thus, in this scenario the exchange would be an individual-to-business exchange.

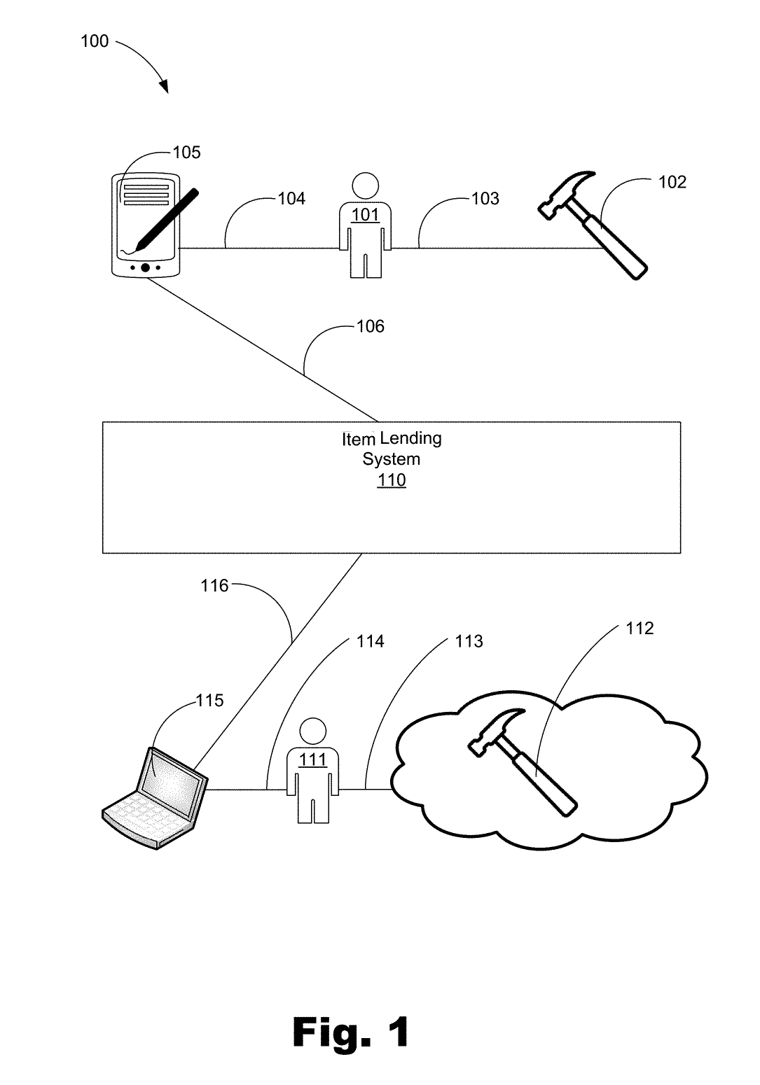

FIG. 1 is a diagram (100) of an item lending system operating an item exchange network, according to the principals described herein. This diagram (100) illustrates an item lending system (110) operating an item exchange network.

As illustrated in FIG. 1, a first user (111) desires a desired item (112). The first user (111) does not possess the desired item (112), but is thinking (113) about the desired item (112). (The user and the user's desire to obtain an item are not claimed as part of the inventive apparatus). The first user (111) communicates (114) with a computing device (115) to express the desire to obtain the desired item (112). The computing device may be any computing device such as a personal computer, a laptop computer, a portable computing device such as a tablet or smartphone. The computing device (115) may convert user input into a digital format. The computing device (115) may include data to identify the first user (111). Attributes may include information about the first user (111) such as a name, location, address, billing information, credit card information, rating such as a cumulative rating from other users on the system based on their interactions with the first user, or item checkout history. The item lending system (110) receives the data describing the first user (111).

The item lending system (110) provides item selection data to the computing device (115). The computing device (115) presents the item selection data to the first user (111), allowing the first user to identify an actual item (102), such as a hammer, for which a record that matches the desired item (112). The item selection data may include additional information about an item (102). The item selection data may include a brand, mass or weight of the item, condition of the item, name, a model identification, age of the real item (102), frequency of use, prior users' experience with the real item (102), prior users experience with a second user (101), location of the real item (102), or price data.

The item lending system (110) identifies checkout exchange data. The checkout exchange data describes criteria that must be met by a first user (111) before the first user may receive the item from the second user (101). The checkout exchange data may identify a place and time for the second user (101) to provide the item (102) to the first user (111). In some embodiments, the item lending system (110) may be configured so that the default location for a meeting between the lender and the borrower is an address other than the user' personal residence if there is not a stored association that designates sufficient familiarity between the lender and the borrower. For example, in some embodiments, item lending system (110) may be configured to receive and store information about whether a potential borrow is deemed trusted by the potential lender, and vice versa; additionally, in some embodiments the item lending system (110) may automatically designate an individual, such as a potential borrower, as a trusted individual if the item lending system (110), or an affiliated system, has automatically identified the potential lender's contact information as being stored on the potential lender's smartphone contact or in the potential lender's email service.

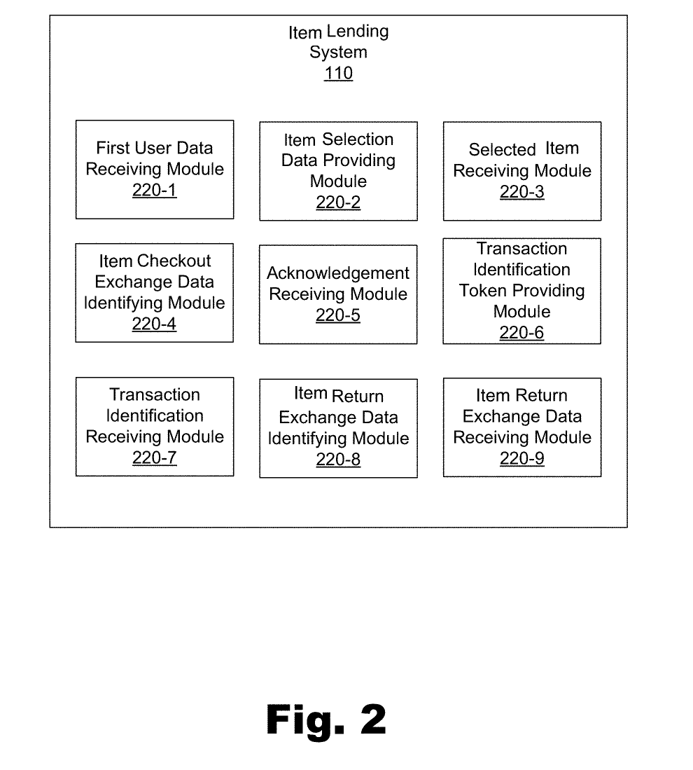

FIG. 2 is an item lending system (110), according to an example of the principles described herein. The item lending system (110) includes a number of modules (220). The modules (220) refer to a combination of hardware and program instructions to perform a designated function. Each of the modules (2220) may include a processor and memory. The program instructions may be stored in the memory and cause the processor to execute the designated function of the modules. As illustrated, the item lending system (110) includes a first user data receiving module (220-1), an item selection data providing module (220-2), a selected item receiving module (220-3), an item checkout exchange data identifying module (220-4), an acknowledgement receiving module (220-5), a transaction identification token providing module (220-6), a transaction identification receiving module (220-7), an item return exchange data identifying module (220-8), and an item return exchange receiving module (220-9).

The first user data receiving module (220-1) may receive first user data from a first user device. In the preferred embodiments, the first user data identifies attributes of a first user. The first user data may include user identification data and authentication information. The first user data may include a location of the first user. The location may include the current location of the user, such as geo-coordinates, as determined by a global positioning (GPS) system. The location may include the residence of the first user. The location may include a business location of the first user. The first user data may include preferences of the first user regarding item selection. The preferences may include a distance from a location associated with the first user. The first user data may include qualifications of the first user. A first user may be qualified to operate a category of items. A user may be approved to check out a certain number of values of items in the item lending network. The first user data may include item selection data, the item selection data informing the item lending system (110) of attributes related to the desired item.

The item selection data providing module (220-2) provides, to the first user's device, a number of items based on item selection data, the item selection data including first user identification data, the first user identification data identifying the first user. The number of items based on item selection data may be based on user input identifying the type of item desired. A user may select from the number of items presented based on item selection data.

The selected item receiving module (220-3) may receive from the first user device information about a selected item, and the information about the selected item may indicate an item the first user will or intends to check out. The item lending system (110) may then process the selection.

The item checkout exchange data identifying module (220-4), may receive, from a second user device, an acknowledgment of the item checkout exchange data. A second user, using the second user device, may accept the item checkout exchange data. The second user, using the second user device, may reject the item exchange data instead of accepting the item checkout exchange data. The second user using the second user device may request a modification to the item checkout exchange data. The item lending system (110) may query the first user to acknowledge the modified item checkout exchange data.

The acknowledgement receiving module (220-5), may receive, from a user, an acknowledgement accepting the item checkout exchange data. A user may be the first user or the second user. The acknowledgement accepting the item checkout exchange data may indicate that the item lending system (110) is authorized to proceed with the transaction.

The transaction identification token providing module (220-6) may provide the first user device with a transaction identification token. The transaction identification token may be used to confirm the identity of the first user. The transaction identification token may consist of numbers, letters, symbols, biometric data, recorded motions, or a combination thereof. In one example, the transaction identification token is a four-digit personal identification token consisting of four numbers. In another example, the transaction identification token is a six-digit personal identification token. In another example, the transaction identification token is a passcode consisting of a combination of letters, numbers and symbols. In still another example, the personal identification token consists of an image of a user fingerprint.

The transaction identification receiving module (220-7), may receive, from the second user device, an entered transaction identification token, wherein receiving the entered transaction identification token from the second user device may confirm the identity of the first user. The entered transaction identification token may be compared with the transaction identification token to confirm the identity of the first user.

The item return exchange data identifying module (220-8) may identify item return exchange data. The item return exchange data may identify a place and time the item is to be returned. The item return exchange identifying module (220-8) may confirm with a user that the user agrees to the item exchange data. The item exchange data may include a transaction identification token to authenticate that an item has been returned to a user associated with the transaction.

The item return exchange receiving module (220-9) may receive return data, wherein the return data may include information describing a return transaction. The return data may indicate the time the item is returned. The return data may indicate a condition of the item. The return data may indicate the satisfaction of each user with the transaction. The return data may include an indication from a user indicating that the user is not satisfied with the transaction. The indication may indicate that the user is under duress in returning the item and allow the user to later enter additional data regarding the transaction when another user is not present.

An overall example of an item lending system (110) according to FIG. 2 will now be given. A first user (FIG. 1, 111) may desires a hammer (FIG. 1, 112) for a task. The first user may not own or possess a hammer. The first user may use a computing device (FIG. 1, 115) to interact with the item lending system (110).

The First User Data Receiving Module (220-1) may receive the first user data. The first user data may describe the first user (FIG. 1, 111). The first user data may include the name and location of the first user. The first user data may indicate that the first user is searching for a hammer. The first user data may indicate that the first user is qualified to use a hammer (FIG. 1, 112). In some embodiments, the indication that a first user may be qualified to use a certain type of item may not necessarily be included as part of the computer-based system. In other embodiments, the checkout of an item that has been classified as relatively dangerous, such as a chainsaw, by a first user may require an acknowledgment by the first user that the first user is qualified to use the item.

One of the allowed search parameters may be distance of an item from a certain location. The item lending system may have a search module that receives information about a desired location, which usually is the first user's home location, the first user's work location, or a public location selected by the first user which is convenient to the first user, such as supermarket nearby the first user's home. The module of the item lending system may then use mapping data to calculate the distance between the desired location and the listed location of an item. In some embodiments, the distance calculated is an “as a bird flies” distance such as the length of a line drawn directly between the two locations. In other embodiments, the distance may be calculated using mapping and travel data that takes into account a mode of transportation, such as a public transit or automobile, and then determines that actual distance as well as time expected to travel between the two locations at a predetermined time, such as within a one hour period falling within the period of rush hour traffic. In some embodiments, a first user who is searching for an item may query the item lending system for all items of a certain type that are located within a five-mile radius or other radius from a certain location. When the item lending system provides search query results to a first user, the query results may be organized or organizable by distance such that a first user may be able to view a chart containing the key information about an item, such as rental price, and also the distance of the item from the first user or the first user's desired location. The item selection data providing module (220-2) provides a number of hammers in the area that meet the criteria established by the first user. The number of hammers differ from each other in make, model, location, age, availability, and cost associated with using each hammer. The item selection data may be provided to the first user (FIG. 1, 111).

The selected item receiving module (220-3) may receive, the selection from a computing device (FIG. 1, 115), such as a smartphone having stored software application instructions on non-transitory storage media, associated with the first user (FIG. 1, 111). The item selected may be a hammer (FIG. 1, 102) owned by a second user (FIG. 1, 101).

The item checkout exchange data identifying module (220-4) may identify a time and location the item will be exchanged or is mutually-scheduled to be exchanged. The item checkout exchange data identifying module (220-4) may use data associated with the first user (FIG. 1, 111) and the second user (FIG. 1, 101) to identify the scheduled time and location. The item checkout exchange data identifying module (220-4) may seek acknowledgement from the first user and the second user. The acknowledgement receiving module (220-5) may receive an acknowledgement from each user representing consent or confirmation to the item checkout exchange data.

The transaction identification token providing module (220-6) provides a transaction identification token to the first user (FIG. 1, 111). The transaction identification token may be entered by the first user on a computing device (FIG. 1, 105) associated with the second user (FIG. 1, 101). The transaction identification token may identify that the first user is a user approved by the item lending system (110) to borrow the item.

The computing device (FIG. 1, 105) associated with the second user (FIG. 1, 101) may receive an entered transaction identification token from the first user (FIG. 1, 111). The transaction identification receiving module (220-7) may receive the entered transaction identification token. The item lending system may confirm the identity of the first user to the second user.

The item return exchange data identifying module (220-8) may identify a time and place to return the borrowed hammer (FIG. 1, 102). The item return exchange data identifying module (220-7) may use the acknowledgement receiving module (220-5) to confirm the return conditions with the first user (FIG. 1, 111) and the second user (FIG. 1, 101).

When the item (FIG. 1, 102) is returned by the first user (FIG. 1, 111) to the second user (FIG. 1, 101), in the preferred embodiments, the computing device (FIG. 1, 115) associated with the first user (FIG. 1, 101) receives an entered transaction identification token from the second user (FIG. 1, 101). The transaction identification receiving module (220-7) may receive the entered transaction identification token. The item lending system may confirm the identity of the second user to the first user. In the preferred embodiments, the transaction identification token which may be used when the first user returns the item or object to the second user may be different than the transaction identification token which may be used when the second user checks out the item or object to the first user. The item lending system 101 may prompt the first user and the second user, with a prompt, that a transaction identification token must be entered in before the transaction may be completed; the prompt may include information about which user should enter in the transaction identification token on which user's device. And the prompt may remind a user what is the transaction identification token; in the preferred embodiments when a second users lends out an item to a first user, the first user enters the first user's identification token onto the second user's device and the identification token is then sent to the item lending system or peer-to-peer exchange management system for verification of the first user. In the preferred embodiments, when the first user brings the item back to the second user for a return exchange, the second user may then be prompted to enter the second user's identification token into the first user's device such as via a smartphone app interface; the second user's identification token may then be sent to the item lending system or peer-to-peer exchange for verification of the second user. Although not required, this type of verification method and system is useful in decreasing fraud where a first user claims that he or she returned the borrowed item when in reality the first user did not; when the first user must enter the first user's identification token into an interface that is presented by the second user's device, then that increases the likelihood that the second user met face to face with the first user and also agreed that the first user had returned the borrowed item. Likewise, entering the first user's identification on the second user's

In some embodiments, each user may be provided a rating request and rating survey from an item lending system (110); the rating request and rating survey may appear on the smartphone of each user; in some embodiments, the rating request may be made via an email message or SMS text message, and in some embodiments the rating survey may be provided via a link such as a link contained in an SMS text message or email message that links to a web survey. In some embodiments, item lending system (110) notifies a third party, and the third party then sends the link for the rating request to the users. In the most preferred embodiments, the rating request and rating survey are sent to each user after the transaction has been completed; however, in some embodiments, the rating request or the rating survey are sent to each user so that the users may complete the rating on their own smartphone device while the first user and second user are at the same location to transfer the item or object from the first user to the second user. In some embodiments users use a smartphone device, but in other embodiments, users may use tablets, computers, or smartwatches.

Either the first user or the second user may rate the transaction as well as the other user; for example, a lender may rate a borrower, and a borrower may rate a lender. The ratings of a user may affect where a user appears in search results as well as the amount of restrictions placed on a user.

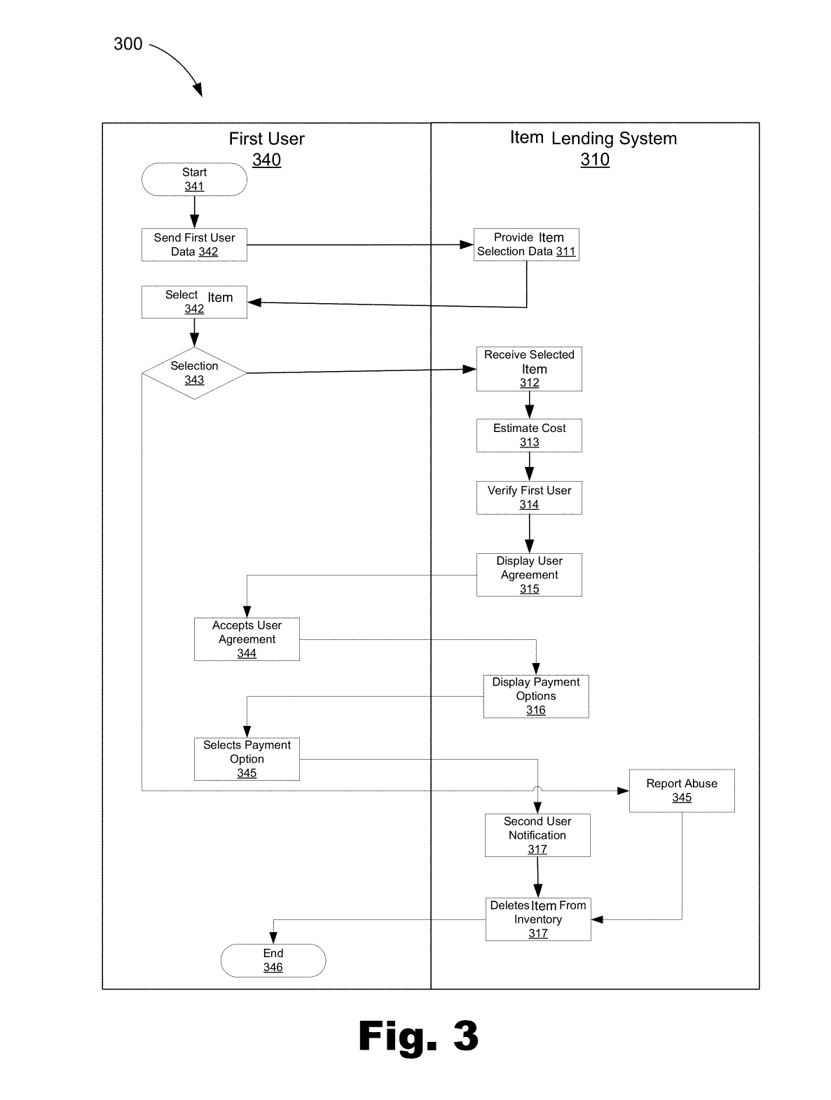

FIG. 3 is a flow chart of activity in an item exchange network, according to another example of the principles described herein. Other flow charts may illustrate examples of the principles described herein.

The flow chart begins with a first user (340) initiating a search for an item. A computing device associated with the first user (340) sends first user data (342) to the item lending system. The first user data describes the first user and the item sought.

The item lending system (310) provides item selection data (311). The item selection data causes a requested items list to appear on a computing device associated with the first user (340). They lender may select a desired item from the list of borrower requirements. The item selection data may display that an item is now available, an item description, an item distance from the borrower, an item lender identification, an item lender rating, a borrowing fee, or an option to view or borrow the item.

The provided item selection data (311) may indicate that no items meeting the criteria are available. When no items are available, the provide item selection data may indicate a method through which the first user will be notified when a new item becomes available. A new item may become available when the item lending system indicates the item has been returned. A new item may become available when the new item is added to the item lending system.

The first user (340) may select an item from the item selection data. When the first user (340) makes a selection, the first user (340) may select (343) the item or may report the listing for abuse (345). When a listing is reported for abuse (345), the item lending system (310) deletes the item from the inventory (317) and the query ends (346).

When the first user selects an item, the item lending system (340) receives the selected item (312). The item lending system (310) estimates costs (313) associated with borrowing the item and verifies the identity of the first user (314). The item lending system then displays a user agreement (315) to the first user (340).

The first user (349) accepts the user agreement, indicating a desire to borrow the item through the item lending system (310). The item lending system (310) may then display payment options (316) to the first user (340). The first user (345) may select a payment option (345). The item lending system (310) may then notify the second user (317), seeking confirmation from the second user as to the terms. When the second user commits to the exchange, the item lending system (310) designates the item as unavailable in inventory during the agreed upon timeframe and the process ends (346).

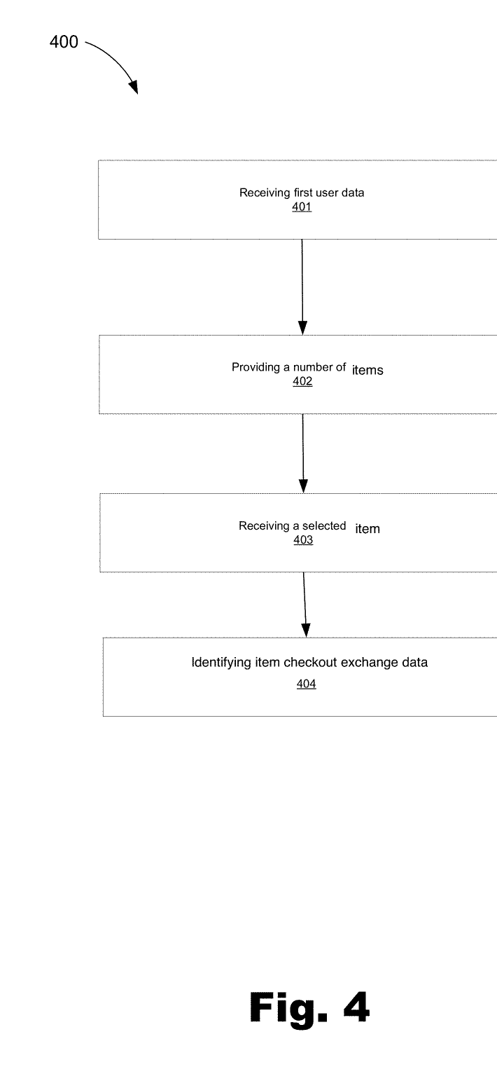

FIG. 4 is a method (400) for operating an item exchange network, according to an example of the principles described herein. In some embodiments, the first step of the method (401) is that an item lending system (110) receives data about a first user from a first user device, and the first user data may contain identifying attributes of a first user. The first user data identifies the first user and the item sought by the first user.

The method (400) includes the item lending system (100) providing (402) to the first user device the details about a plurality of items based on item selection data, wherein the item selection data includes first user identification data, and wherein the first user identification data may be used by item lending system (100) to identify the first user. The item selection data which is stored on item lending system (100) and displayed to the first user may be used by the first user to select and request an item. The method (400) includes the item lending system (100) receiving from the first user device a selected item, the selected item indicating an item the first user desires to checkout. The method (400) includes using the item lending system (100) then proceeds to check out the selected item.

The method (400) identifies (404) item checkout exchange data, the item checkout exchange data identifying a place and time the item is to be exchanged for check out. The item checkout exchange data describes a place and time the first user is to obtain the item from a second user who possesses the item.

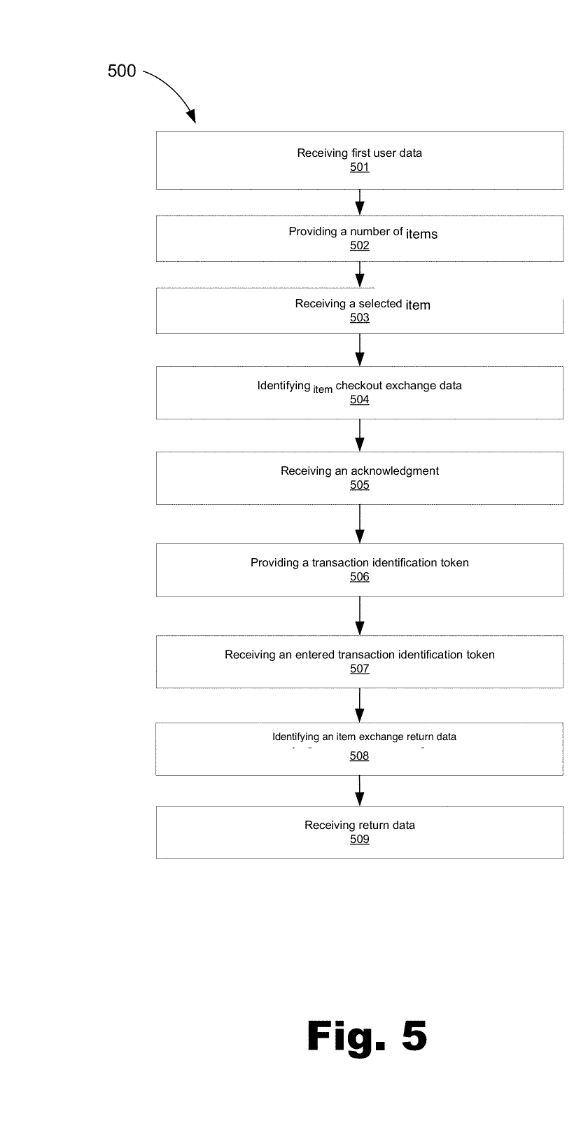

FIG. 5 is a method (500) for operating an item exchange network, according to an example of the principles described herein. As described above, the method (500) receives (501) first user data, provides (502) a number of items for selection, receives (503) a selected item and identifies (504) item checkout exchange data.

The method (500) receives (505), from a second user device, an acknowledgment of the item checkout exchange data. The acknowledgement of the item exchange data indicates that a second user consents to the item loan. The acknowledgment may be one of an acceptance, rejection, or modification of the item checkout exchange data.

The method (500) provides (506) the first user device with a transaction identification token, the transaction identification token confirming the identity of the first user. The transaction identification token is used by the first user to provide authentication of identity on a second computing device associated with a second user.

The method (500) receives (507), from the second user device, an entered transaction identification token, wherein receiving the entered transaction identification token from the second user device confirms the identity of the first user. The first user enters the transaction identification token on the device of the second user to authenticate identity. This allows the second user to authenticate the first user's identity without checking identification cards.

The method (500) may identify (507) item return exchange data, the item return exchange data identifying a place and time the item is to be returned. The item return exchange data allows the first user to return the item to the second user.

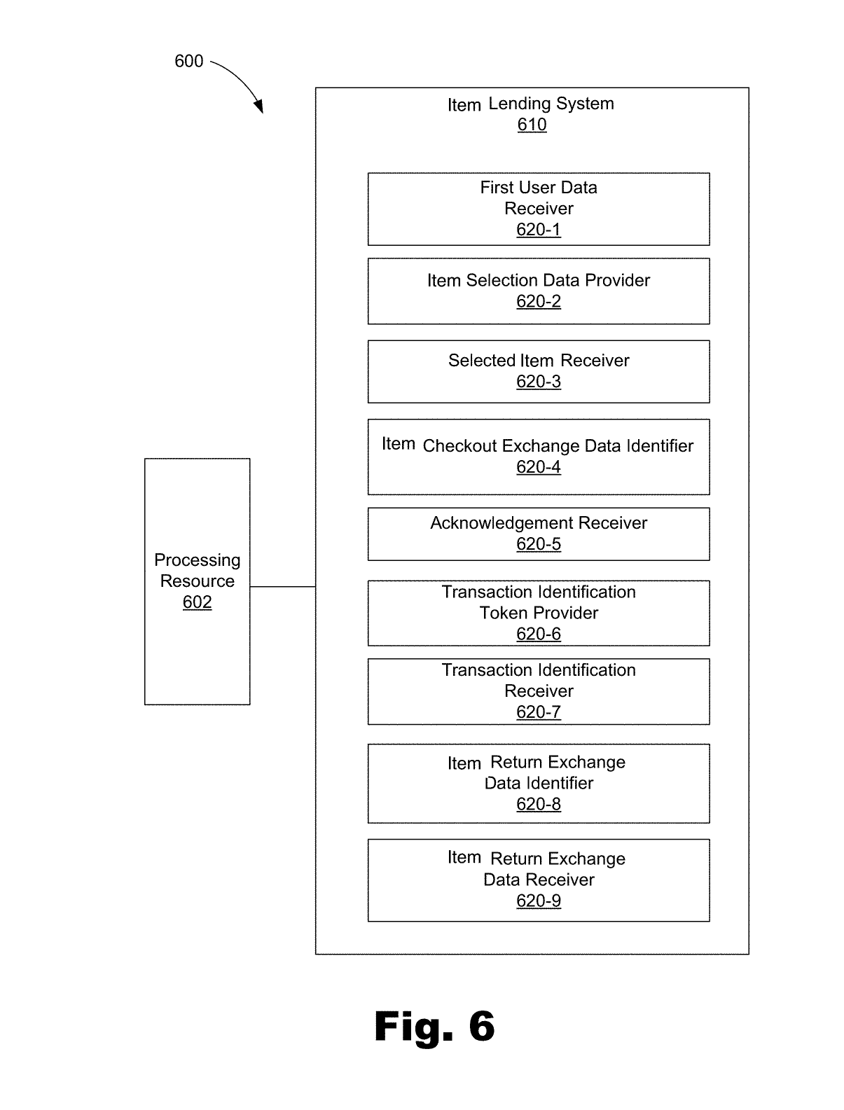

FIG. 6 is a block diagram of a system (600), including a computer program product for operating an item exchange network, according to an example of the principles described herein.

The system (600) may be implemented on an electronic device. Examples of electronic devices include servers, desktop computers, laptop computers, personal digital assistants (PDAs), mobile devices, smartphones, gaming systems, and tablets, among other electronic devices.

The system (600) may be utilized in any data processing scenario. including stand-alone hardware, mobile applications, a computing network, or combinations thereof. Further, the system (600) may be used in a computing network, a public cloud network, a private cloud network, a hybrid cloud network, other forms of networks, or combinations thereof. In one example, the methods provided by the system (600) are provided as a service over a network by, for example, a third party. In this example, the service may comprise, for example, the following: a Software as a Service (SaaS) hosting a number of applications; a Platform as a Service (PaaS) hosting a computing platform comprising, for example, operating systems, hardware, and storage, among others; an Infrastructure as a Service (IaaS) hosting equipment such as, for example, servers, storage components, network, and components, among others; application program interface (API) as a service (APIaaS), other forms of network services, or combinations thereof. The present systems may be implemented on one platform or multiple hardware platforms, in which the modules in the system can be executed on one platform or across multiple platforms. Such modules can run on various forms of cloud technologies and hybrid cloud technologies or offered as a SaaS (Software as a Service) that can be implemented on or off the cloud. In another example, the methods provided by the system (600) are executed by a local administrator.

The system (600) includes a processing resource (602) which may include the hardware architecture to retrieve executable code from the item lending system (610) and execute the executable code. The executable code may, when executed by the processor (602), cause the processor (602) to implement at least the functionality of operating an item lending system (610), according to the methods of the present specification described herein. In the course of executing code, the processor (602) may receive input from and provide output to a number of the remaining hardware units.

The item lending system (610) may store data such as executable program code that is executed by the processor (602) or other processing device. As will be discussed, the item lending system (610) may specifically store computer code representing a number of applications that the processor (602) executes to implement at least the functionality described herein.

The item lending system (610) further comprises a number of modules used in the implementation of lending items between users. The various modules within the item lending system (610) may comprise executable program code that may be executed separately. In this example, the various modules may be stored as separate computer program products. In another example, the various modules within the item lending system (610) may be combined within a number of computer program products; each computer program product comprising a number of the modules.

The item lending system (610) may include a first user data receiver (620-1) to receive, from a first user device, first user data, the first user data identifying attributes of a first user.

The item lending system (610) may include an item selection data provider (620-2) to provide, to the first user device, a number of items based on item selection data. The item selection data includes first user identification data. The first user identification data identifies the first user.

The item lending system (610) may include a selected item receiver (620-3) to receive, from the first user device, a selected item, the selected item indicating an item the first user will check out.

The item lending system (610) may include an item checkout exchange data identifier (620-4) to identify item checkout exchange data, the item checkout exchange data identifying a place and time the item is to be exchanged for checkout.

The item lending system (610) may include an acknowledgement receiver (620-5) to receive an acknowledgement regarding the exchange of an item.

The item lending system (610) may include a transaction identification token provider (620-6) to provide the first user with a transaction identification token. The transaction identification token is used to confirm the identity of the first user. In some embodiments, a unique identification token is provided to the first user and a different unique identification token is provided to the second user; the tokens may be provided when then users create their initial user account. In some embodiments, a user may use their unique identification token in place of the transaction identification token. In the preferred embodiments, no two active users may be given the same identification token. In some embodiments, the transaction identification token may be a relatively simple token such as “1769”, and in some embodiments the transaction identification token may be user configurable. In some embodiments, a user may reuse the transaction identification token to identify himself or herself to the item lending system (101) during subsequent transactions.

The item lending system (610) may include a transaction identification receiver (620-7) to receive, from the second user device, an entered transaction identification token. The entered transaction identification token from the second user device confirms the identity of the first user.

In the preferred embodiments, a first user and a second user must be logged into the item lending system such that user identification credentials have been identified by the item lending system while the first user and second user complete the transaction.

The item lending system (610) may include an item return exchange data identifier (620-8) to identify item return exchange data. The item return exchange data identifies a place and time the item is to be returned.

The item lending system (610) may include an item return data receiver (620-9) to receive return data, wherein the return data includes information describing a return transaction. The return data may indicate an objection to the return.

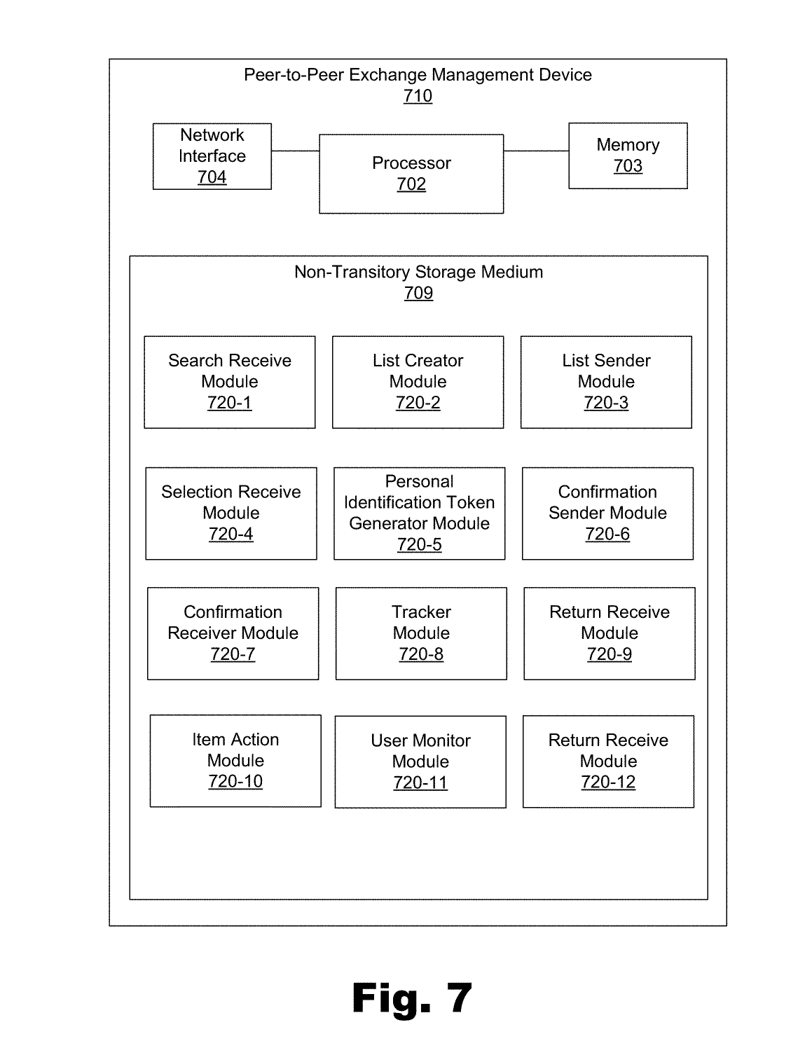

FIG. 7 illustrates a peer-to-peer management device (710) for managing the exchange of a selected item in a peer-to-peer exchange. The device includes a processor (702) communicatively connected to memory (703), a network interface (704), and a non-transitory storage medium (709).

A non-transitory storage medium (709) includes a number of modules (720). Each module (720) may consist of a combination of hardware and software. Each module may include a processor capable of executing computer program code. The processor associated with each module may cause the module to execute computer program code to perform a particular task. The computer program code may include instructions stored as part of software or hardware.

A search receive module (720-1) receives, from a first device, an item request data packet.

A list creator module (720-2) generates a list of a number of items based on the item request data packet after retrieving data associated with a plurality of items stored in a database of items.

A list sender module (720-3) sends to the first device a list of a number of items based on the item request data packet. The number of items of the list may be a list of a number of items. The list of the number of items may be presented based on a distance parameter measured from the first user, a performance rating of a second user, condition of each of the number of items, price of each of the number of items, lender name, or combination thereof. The list of the number of items may be presented in an order based on the mass of each item. The list of the number of items is presented based on inclusion within a mass threshold.

A selection receive module (720-4) receives, from the first device, an item selection identifying the selected item from the list of a number of items.

A personal identification token generator module (720-5) generates a first personal identification token identifying a first user and a second personal identification token identifying a second user.

A confirmation sender module (720-6) sends an amount of sent confirmation data to the first device and a second device.

A confirmation receiver module (720-7) receives, from at least one of the first device and the second device, an amount of confirmation data.

A tracker module (720-8) tracks possession of the selected item. The tracker module (720-8) modifies a use record associated with the selected item; the device of claim 1 further comprising an item monitor module, the item monitor module monitoring the use record associated with the selected item. The tracker module (720-8) may receive, from the second device, the first personal identification token that has been generated by the personal identification token generator module and inputted into the second device and receive, from the first device, the second personal identification token that has been generated by the personal identification token generator module.

A return receive module (720-9) receives information regarding the return of an item to a user associated with a second device. A return status may be selected from the group consisting of an indication that the item was returned no damage, returned with cosmetic damage, or returned no longer functioning.

An item action module (720-10) to invoke an action based on the use record associated with the selected item.

A user monitor module (720-11) monitors an amount of activity of a user record representing a first user that has borrowed the selected item and an amount of activity of a user record representing a second user that has lent the selected item to the first user.

A return receive module (720-12) receives data confirming the return of the selected item to the second user.

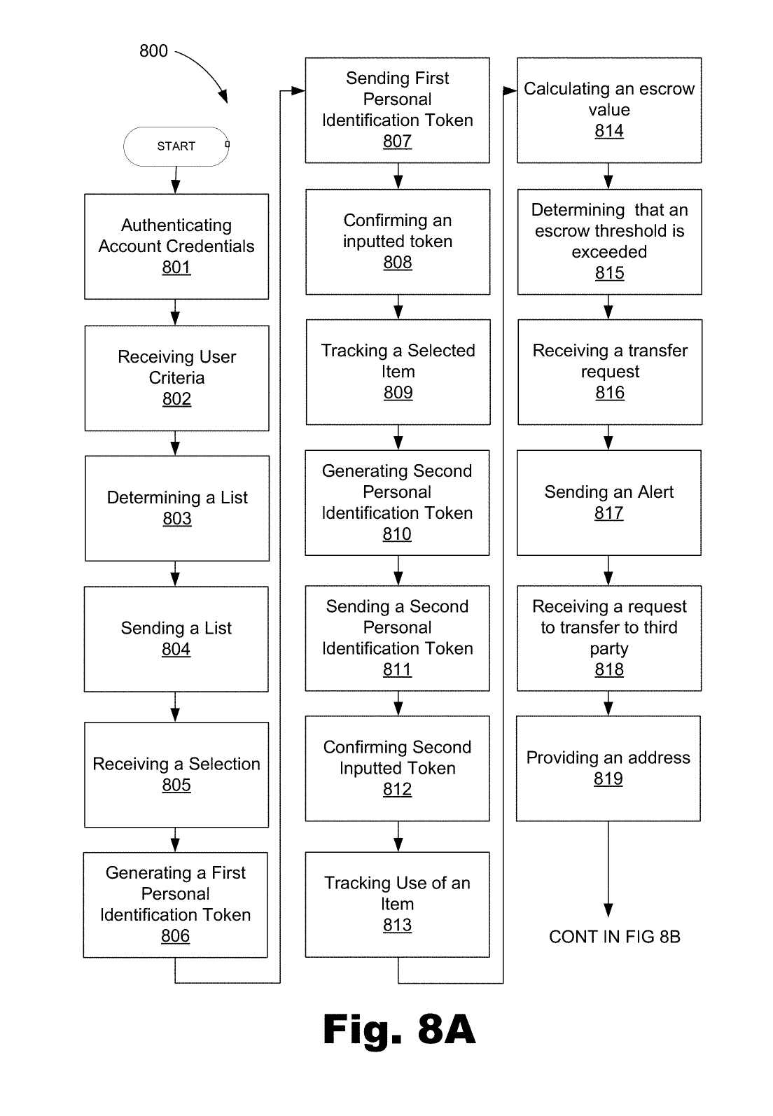

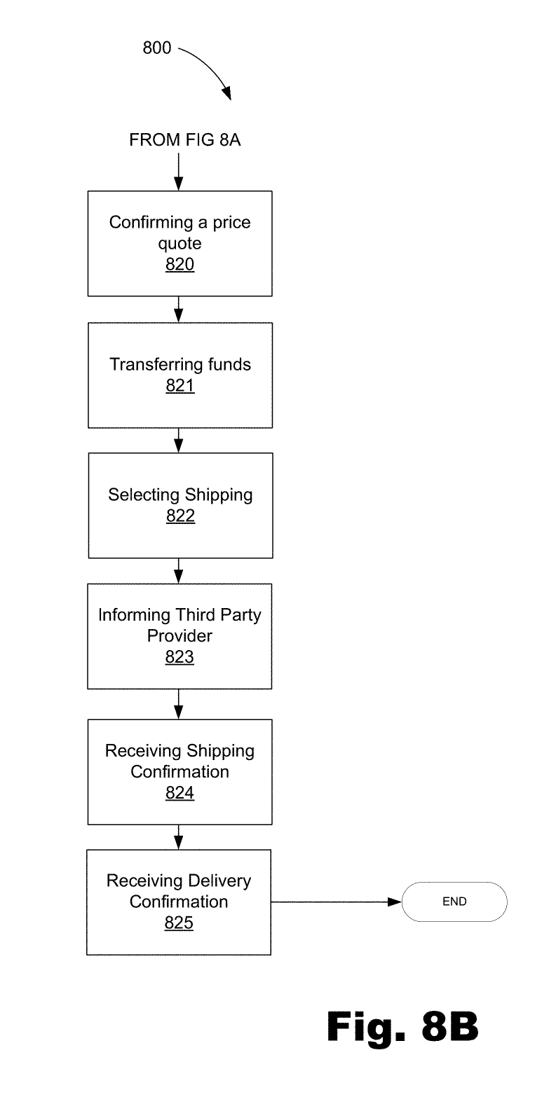

FIG. 8A describes a first part of a method to for exchange at least one selected item using a peer-to-peer management device for managing the exchange of at least one selected item in a peer-to-peer exchange. The method may include a number of steps. Each step may be performed individually or in combination with other steps.

The method (800) may include authenticating (801) account credentials. The account credentials identify a user and user attributes associated with a device.

The method (800) may include receiving (802), via a search receive module of the peer-to-peer management device, a list of user criteria from the first device, the user criteria identifying a plurality of attributes of at least one item of the plurality of items.

The method (800) may include determining (803), via a list create module of the peer-to-peer management device, a list presenting a plurality of items, each item of the portion of the plurality of items possessing at least one criteria matching at least one user criteria.

The method (800) may include sending (804), via a list sending module of the peer-to-peer management device, the list presenting the plurality of items to the first device.

The method (800) may include receiving (805), via a selection receive module of the peer-to-peer management device, a user selection. The user selection being an item in the list of the number of items.

The method (800) may include generating (806) a first personal identification token, by a personal identification token generator of the peer-to-peer management device. The first personal identification token identifies a user of the first device.

The method (800) may include confirmation sending (807), by a confirmation sender module of the peer-to-peer management device, when the first personal identification token has been created by the peer-to-peer management device, to the first device.

The method (800) may include confirming receiver (808), via a confirmation receive module of the peer-to-peer management device, an inputted token on a second device matches the first personal identification token.

The method (800) may include tracking (809), via a tracking module of the peer-to-peer management device, the possession of the selected item.

The method (800) may include generating (810) a second personal identification token, by a personal identification token generator of the peer-to-peer management device. The second personal identification token identifies the user of the second device.

The method (800) may include sending (811), by a confirmation sender module of the peer-to-peer management device, when the second personal identification token has been created by the peer-to-peer management device, to the second device the second personal identification token.

The method (800) may include confirming (812), to the first device, a second token, when the first device receives the second personal identification token.

The method (800) may include tracking (813), via a tracking module of the peer-to-peer management device, the use of the selected item. The tracking (813) may include recording, within time interval from the time in which the confirmation token was inputted by the second user, the geo-coordinates. The tracking (813), via a tracking module of the peer-to-peer management device, the use of the selected item. The tracking may include receiving the return data from the first device includes selection condition data, the selection condition data including at least one of a damaged-condition status, a description of the damaged-condition status, a settlement amount, or a photograph file of the item.

The method (800) may include calculating (814) an escrow account value, via an escrow account module using an escrow account value algorithm that accounts for the initial condition and data representing the number of times reported to the peer-to-peer management device that the item has been borrowed.

The method (800) may include determining (815), via the escrow account value algorithm, that a value of an escrow account of the second user has reached the replacement threshold for the item and sending an alert to the second device of the second user wherein the alert informs the second user that the value of the escrow account of the second user has reached the replacement threshold.

The method (800) may include receiving (816) a transfer request from the second user and in response to the request, transferring at least some of the value of the escrow account to a financial account authorized by the second user.

The method (800) may include sending (817) an alert to the second user informing the second user that the second user escrow account has reached the replacement-with-shipping value.

The method (800) may include receiving (818) a request from the second user requesting that the escrow account value be transferred to a third party and that the second user be provided free shipping and a type of shipping speed.

The method (800) may include providing (819) an address requesting a price quote plus shipping quote.

FIG. 8B represents a continuation of the method in FIG. 8A. The method (800) may include confirming (820) that a price quote plus shipping quote does not exceed the value of the escrow account of the second user.

The method (800) may include transferring (821) the replacement-with-shipping-value of the second user escrow to a third-party provider.

The method (800) may include selecting (822) the shipping speed. The shipping speed may be selected based on cost, delivery time, user preferences, or demand of the item.

The method (800) may include informing (823) the third-party provider to ship the consumer product to the second user.

The method (800) may include receiving a shipping confirmation from either the third-party provider of the shipping agent of the third-party provider.

The method (800) may include receiving (824) a delivery confirmation. The delivery confirmation may include information related to the delivery of the item.

The method (800) may include reducing (825) the value of the escrow account by the replacement cost and shipping cost.

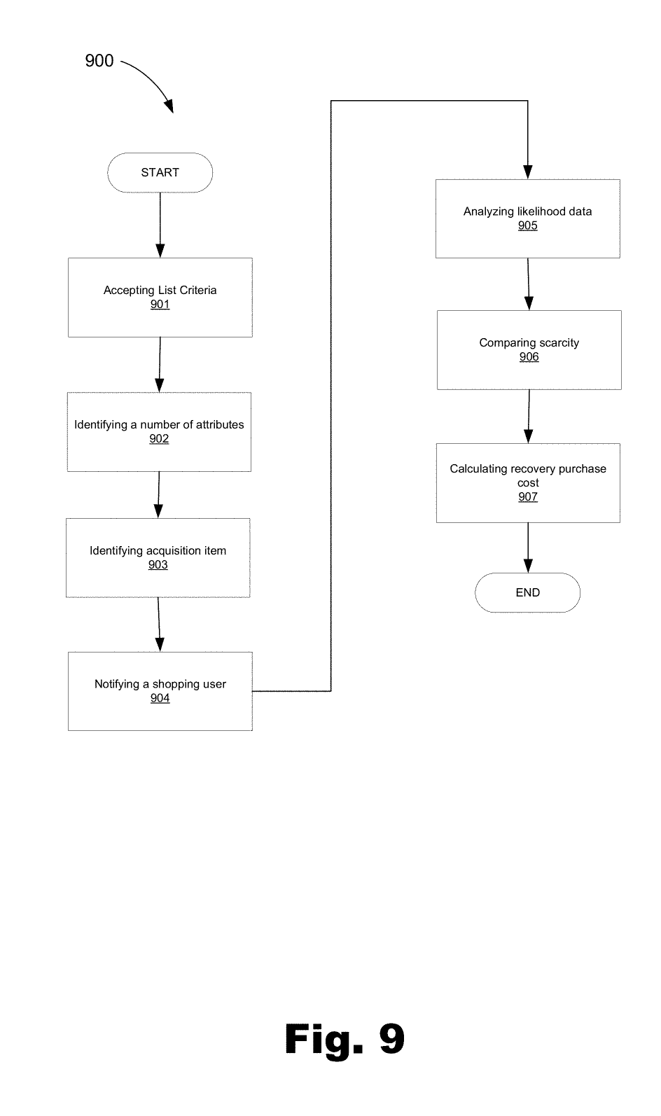

FIG. 9 represents a method or identifying items to acquire a peer-to-peer management device for managing the exchange of the at least one selected item in a peer-to-peer exchange, according to one example of the principles described herein.

The method (900) may include accepting (901), via a potential purchase module of the peer-to-peer management device, the potential purchase module receiving a list user criteria.

The method (900) may include identifying (902) a number of attributes of a number of user desired items.

The method (900) may include identifying (903), via a targeted acquisition module, an acquisition item, the acquisition item being an item that meets the list user criteria and the list of user criteria identifying a number of attributes of a number of user desired item.

The method (900) may include notifying (904), via an acquisition opportunity module, a shopping user of the acquisition item.

The method (900) may include analyzing (905), via a tracking module, data from a database of items to identify a value representing the likelihood an item will be exchanged in the future.

The method (900) may include comparing (906), based on the value representing the likelihood an item will be exchanged in the future to identify a scarcity list, the scarcity list being a list of items that are underrepresented in the database.

The method (900) may include calculating (907), based on logged search criteria and the scarcity list, an anticipated time to recover purchase costs of an item.

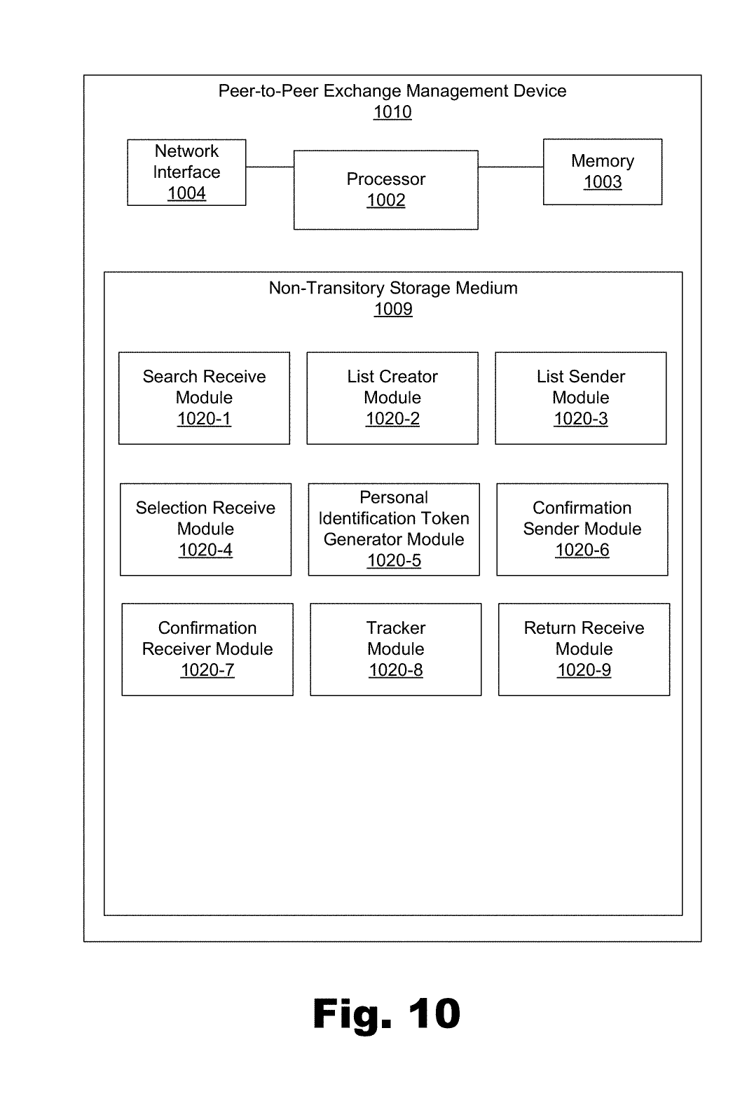

FIG. 10 illustrates a peer-to-peer management device (1010) for managing the exchange of a selected item in a peer-to-peer exchange. The device includes a processor (1002) communicatively connected to memory (1003), a network interface (1004), and a non-transitory storage medium (1009).

A non-transitory storage medium (1009) includes a number of modules (1020). Each module (1020) may consist of a combination of hardware and software. Each module may include a processor capable of executing computer program code. The processor associated with each module may cause the module to execute computer program code to perform a particular task. The computer program code may include instructions stored as part of software or hardware.

A search receive module (1020-1) receives, from a first device, an item request data packet.

A list creator module (1020-2) generates a list of a number of items based on the item request data packet after retrieving data associated with a plurality of items stored in a database of items.

A list sender module (1020-3) sends to the first device a list of a number of items based on the item request data packet. The number of items of the list may be a list of a number of items. The list of the number of items may be presented based on a distance parameter measured from the first user, a performance rating of a second user, condition of each of the number of items, price of each of the number of items, lender name, or combination thereof. The list of the number of items may be presented in an order based on the mass of each item. The list of the number of items are presented based on inclusion within a mass threshold.

A selection receive module (1020-4) receives, from the first device, an item selection identifying the selected item from the list of a number of items.

A personal identification token generator module (1020-5) generates a first personal identification token identifying a first user and a second personal identification token identifying a second user.

A confirmation sender module (1020-6) sends an amount of sent confirmation data to the first device and a second device.

A confirmation receiver module (1020-7) receives, from at least one of the first device and the second device, an amount of confirmation data.

A tracker module (1020-8) tracks possession of the selected item. The tracker module (1020-8) modifies a use record associated with the selected item; the device of claim 1 further comprising an item monitor module, the item monitor module monitoring the use record associated with the selected item. The tracker module (1020-8) may receive, from the second device, the first personal identification token that has been generated by the personal identification token generator module and inputted into the second device and receive, from the first device, the second personal identification token that has been generated by the personal identification token generator module.

A return receive module (1020-9) receives information regarding the return of an item to a user associated with a second device. A return status may be selected from the group consisting of an indication that the item was returned no damage, returned with cosmetic damage, or returned no longer functioning.

An overall example according to FIG. 10 will now be given. In this example, a first user (FIG. 1, 111) desires to borrow an item. In this example, the item is a hammer (FIG. 1, 102). The first user (FIG. 1, 111) enters criteria that describes to type of hammer that is desired. The criteria may specify the type of hammer, size of hammer, age of hammer, weight of hammer, and proximity from the first user (FIG. 1, 111)

A search receive module (1020-1) associated with the Peer-to-Peer Exchange Management Device (1010) may receive the search criteria to identify the hammer. This search criteria may be received by the Peer-to-Peer Exchange Management Device (1010) using the Network Interface (1004).

The Peer-to-Peer Exchange Management Device (1010) creates a list using the list creator module (1020-2). The list creator module (1020-2) may search a database of items to identify a number of items that meet the criteria received. The list creator module (1020-2) may contact a server or a different device to identify a number of items to present in a list to the first user (FIG. 1, 111).

The Peer-to-Peer Exchange Management Device (1010) may send, using a list sender module (1020-3) to send the list to a device (FIG. 1, 115) associated with the first user (FIG. 1, 111)

The Peer-to-Peer Exchange Management Device (1010) may receive, using the selection receive module (1020-4), the selection the first user (FIG. 1, 111) desires. In this example, the first user (FIG. 1, 111) desires a hammer (FIG. 1, 102) in the possession of a second user (FIG. 1, 101).

The Peer-to-Peer Exchange Management Device (1010) may generate, using the personal identification token generator module (1020-5), a number of personal identification tokens. In this example, the personal identification token generator module (1020-5) is used to generate a first personal identification token that is used to identify the first user (FIG. 1, 111) and a second personal identification token that is used to identify the second user (FIG. 1, 101)

The confirmation sender module (1020-6) may confirm the selection of the hammer (FIG. 1, 102) and sends notice to the first user device (FIG. 1, 115) and the second user device (FIG. 1, 105) identifying the transaction and sending the personal identification token for the user associated with that device.

The first user (FIG. 1, 111) meets the second user (FIG. 1, 101) to exchange the hammer (FIG. 1, 102). Upon meeting, the first user (FIG. 1, 111) may enter the first personal identification token on the second device (FIG. 1, 105) associated with the second user (FIG. 1, 101). When the first user (FIG. 1, 111) enters the first personal identification token on the second device (FIG. 1, 105) an acknowledgment is displayed that the first user (FIG. 1, 111) has a confirmed identity.

The tracker module (1020-8) tracks the possession of the hammer (FIG. 1, 102). The possession is used to identify the user that may bear the financial responsibility for the hammer. The tracker module (1020-8) may create a bill for the first user (FIG. 1, 111) for the amount of time the first user possesses the hammer).

The Peer-to-Peer Exchange Management Device (1010) validates the return of the hammer (FIG. 1, 102). The second user (FIG. 1, 101) enters the second personal identification token on the first device (FIG. 1, 115) to confirm the identity of the second user (FIG. 1, 101) and record the return of the hammer (FIG. 1, 102) to the second user (FIG. 1, 101).

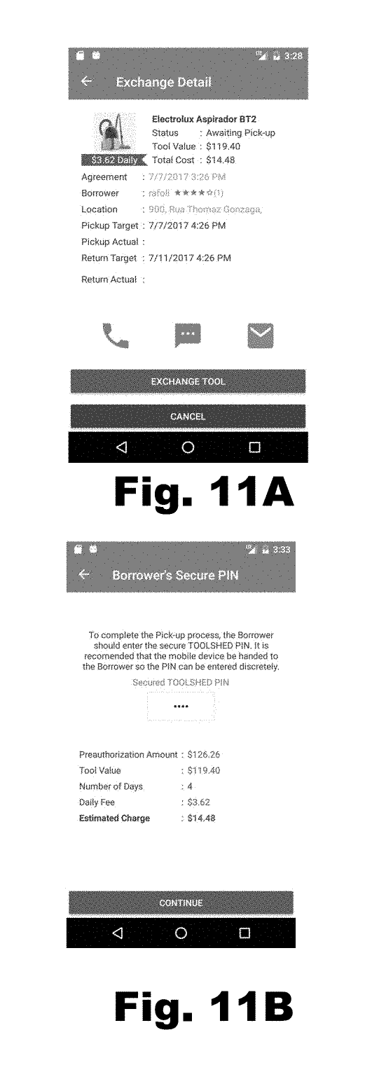

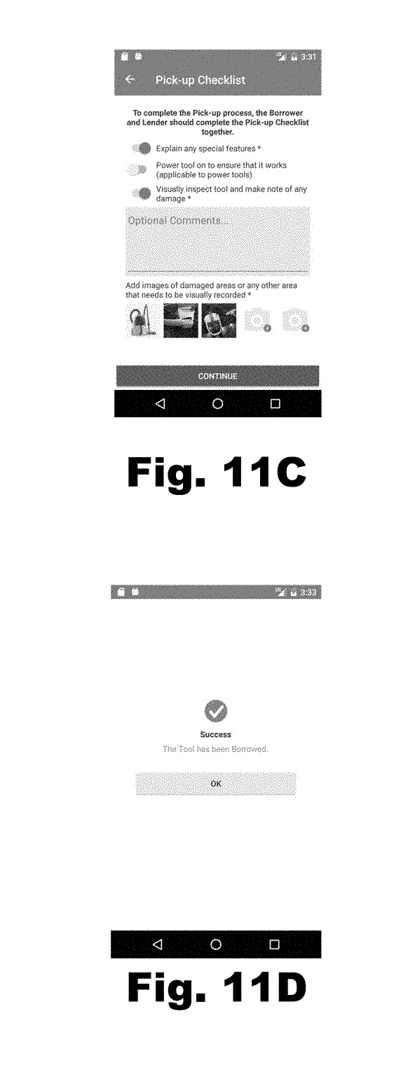

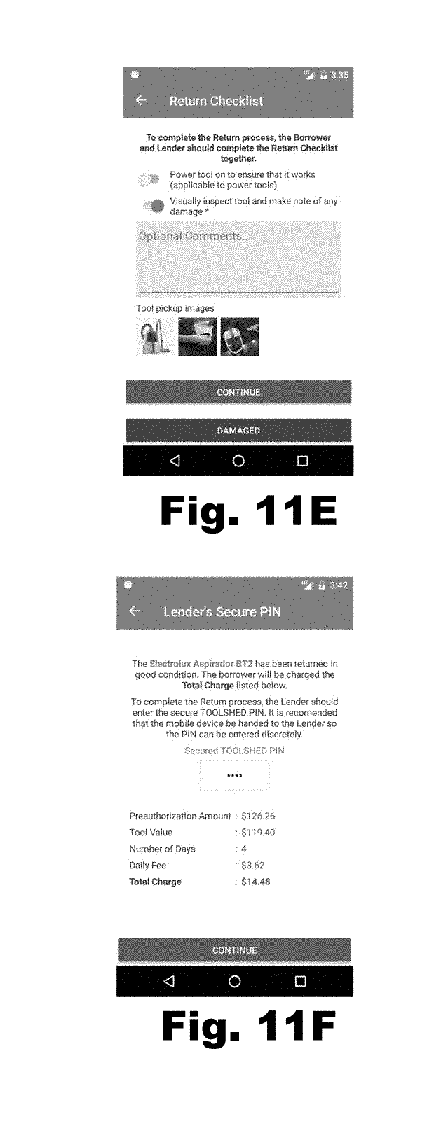

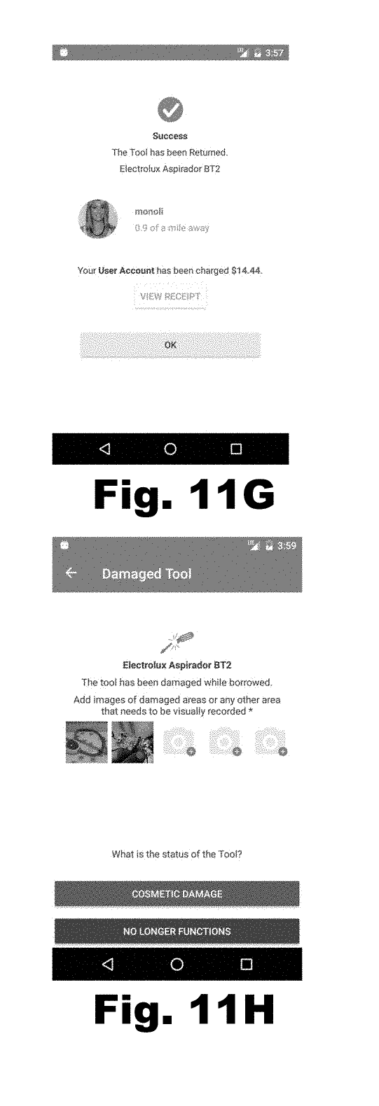

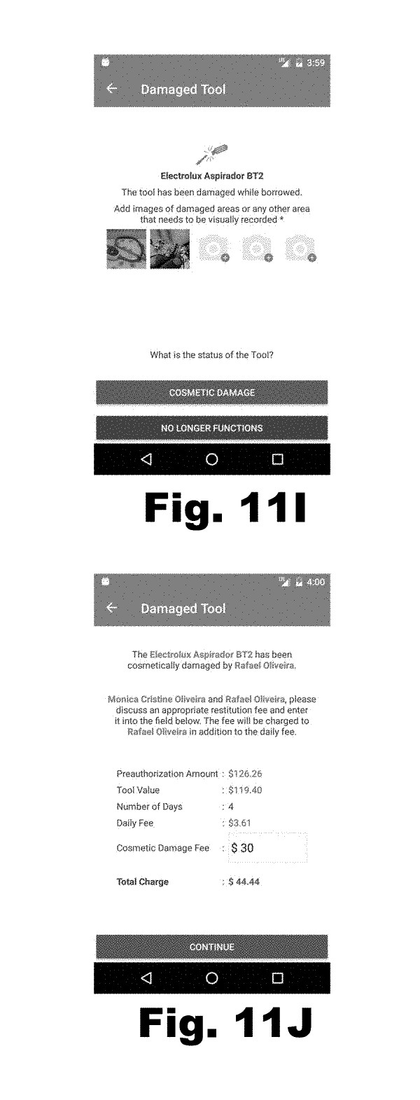

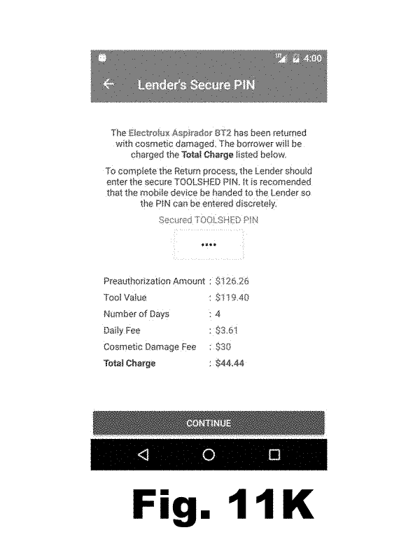

FIG. 11A through FIG. 11K are examples of a number of interfaces that may be used in interacting with a peer-to-peer exchange management device.

FIG. 11A represents an example of an item that has been selected for exchange. This item specifies a time of an agreement, a borrower, an exchange location, a pickup target time and a return target time.

FIG. 11B represents an example of an interface presentation for a borrower where the cost of borrowing the item is displayed, including an option to display a personal identification token that is labelled “Secured TOOLSHED PIN.”

FIG. 11C represents an example of an interface presentation at an item exchange to remind a number of users of steps to take in exchanging an item.

FIG. 11D represents an example of an acknowledgment of a successful item exchange.

FIG. 11E represents an example of an interface presentation at an item exchange to remind a number of users of steps to take in returning an item.

FIG. 11F represents an example of an interface presentation for a lender where the cost of borrowing the item is displayed, including an option to display a personal identification token that is labelled “Secured TOOLSHED PIN.”

FIG. 11G represents an example of an acknowledgment of a successful item returned.

FIG. 11H represents an example of an interface for reporting damage to an item.

FIG. 11I represents an example of an interface for reporting damage to an item by recording photographs of the damage.

FIG. 11J represents an example of an interface for settling damage costs to an item.

FIG. 11K represents an example of an interface presentation for a lender where the cost of borrowing the item is displayed, including an option to display a personal identification token that is labelled “Secured TOOLSHED PIN.”

For purposes of this disclosure, maximum deprecation is the maximum amount that an item can decline in value, based upon its expected annual depreciation. For example, if an item depreciates 10% of the original value per year, when the item reaches 10 years in age it has depreciated 100% and therefore has no value. If the maximum depreciation, is set to 50% by an item lending system, this limits the amount the item can depreciate, limiting it to less than or equal to 50%. Therefore, an item that is 10 years old will always have a value that is 50% or greater than the original value when the item was brand new.

In some embodiments, the system calculates an incentive for lenders, borrowers, or both lenders and borrowers. In some embodiments, the incentive is set between 2% and 30% of the value of renting the item or other object. In other embodiments, the incentive is calculated as the greater of a) a set daily rate, such as $2/day or $1 day, and b) the value of the lender incentive percentage multiplied by the item replacement fee. Annual depreciation may be set at a ten-year default and may be calculated as a minimum of 40% or 50% of the item replacement cost. In some embodiments, an item replacement fee is placed in an item replacement escrow; in the most preferred embodiments, each transaction in which an item is rented out results in a configurable fraction of the item replacement fee being placed in an item replacement escrow account. Various variables may be used in any algorithm used to calculate the item replacement fee, such as the life expectancy of an item, the maximum depreciation, and the number of days that an item is expected to be used as a rental annually. The amount of incentive for renting an item may be based all or partly on the geographical market in which the owner of the item is based or the geographical market in which the item is lent; the system may be used to store data which may be used to determine the overall volume of item rental in an area, the number of potential customers in an area, the number of dollars spent on item rental using the system from users residing within a set distance from an owner's address of residence, such as within a 50 mile radius, or other data that may be useful for adjusting the item incentive fee per user. In some embodiments a lender who resides in an area with a relatively high volume of borrower transactions when compared to other areas may be paid a relatively higher incentive; in other embodiments a lender who resides in an area with a relatively low volume of borrower transactions when compared to other areas may be paid a relatively higher incentive; in other embodiments a lender who has a relatively higher amount of lending transactions compared to other lenders in the same area may be paid a higher incentive payment; in other embodiments a lender who has a relatively higher amount of lending transactions compared to other lenders who lend similar items in the same area may be paid a higher incentive payment.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA), may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A peer-to-peer management device for managing the exchange of a selected item in a peer-to-peer exchange, the device comprising:
a processor;
memory, communicatively connected to a processor;
a network interface, the network interface communicatively connected to the processor;
a non-transitory storage medium, communicatively connected to the processor, the non-transitory storage medium containing:
a search receive module, the search receive module receiving, from a first device, an item request data packet;
a list creator module, the list creator module generating a list of a number of items based on the item request data packet after retrieving data associated with a plurality of items stored in a database of items;
a list sender module, the list sender module sending to the first device a list of a number of items based on the item request data packet;
a selection receive module, the selection receive module receiving, from the first device, an item selection identifying the selected item from the list of a number of items;
a personal identification token generator module, the personal identification token generator module generating a first personal identification token identifying a first user and a second personal identification token identifying a second user;
a confirmation sender module, the sender module sending an amount of sent confirmation data to the first device and a second device;
a confirmation receiver module, the confirmation receiver receiving, from at least one of the first device and the second device, an amount of confirmation data;
a tracker module, the tracker module tracking possession of the selected item; and
a return receive module, the return receive module receiving data confirming the return of the selected item to the second user.

2. The device of claim 1, wherein the tracker module modifies a use record associated with the selected item; the device of claim 1 further comprising an item monitor module, the item monitor module monitoring the use record associated with the selected item.

3. The device of claim 1, further comprising an item action module, the item action module invoking an action based on the use record associated with the selected item.

4. The device of claim 1, further comprising a user monitor module, the user monitor module monitoring an amount of activity of a user record representing a first user that has borrowed the selected item and an amount of activity of a user record representing a second user that has lent the selected item to the first user.

5. The device of claim 1, wherein the confirmation receiver module further comprises receiving, from the second device, the first personal identification token that has been generated by the personal identification token generator module and inputted into the second device and receiving, from the first device, the second personal identification token that has been generated by the personal identification token generator module.

6. The device of claim 1, wherein the return receiver module receives an acknowledgement from the first device confirming the return of the selected item to the second user as well as the return status of the selected item, wherein the return status is selected from the group consisting of an indication that the item was returned no damage, returned with cosmetic damage, or returned no longer functioning.

7. The device of claim 1, wherein the number of items of the list are a number of tools.

8. The device of claim 1, wherein the list of the number of items are presented based on a distance parameter measured from the first user, a performance rating of a second user, condition of each of the number of items, price of each of the number of items, lender name, or combination thereof.

9. The device of claim 1, wherein the list of the number of items are presented in an order based on the mass of each item.

10. The device of claim 9, where the list of the number of items are presented based on inclusion within a mass threshold.

11. A method for exchanging at least one selected item using a peer-to-peer management device for managing the exchange of the at least one selected item in a peer-to-peer exchange, the method comprising:
receiving, via a search receive module of the peer-to-peer management device, a list of user criteria from the first device, the user criteria identifying a plurality of attributes of at least one item of the plurality of items;
determining, via a list create module of the peer-to-peer management device, a list presenting a plurality of items, each item of the portion of the plurality of items possessing at least one criteria matching at least one user criteria,
sending, via a list sending module of the peer-to-peer management device, the list presenting the plurality of items to the first device;
receiving, via a selection receive module of the peer-to-peer management device, a user selection, the user selection being an item in the list of the number of items;
generating a first personal identification token, by a personal identification token generator of the peer-to-peer management device, the first personal identification token identifying the user of the first device;
confirmation sending, by a confirmation sender module of the peer-to-peer management device, when the first personal identification token has been created by the peer-to-peer management device, to the first device;
confirming receiver, via a confirmation receive module of the peer-to-peer management device, an inputted token on a second device matches the first personal identification token;
tracking, via a tracking module of the peer-to-peer management device, the possession of the selected item.

12. The method of claim 11, further comprising:
generating a second personal identification token, by a personal identification token generator of the peer-to-peer management device, the second personal identification token identifying the user of the second device;
sending, by a confirmation sender module of the peer-to-peer management device, when the second personal identification token has been created by the peer-to-peer management device, to the second device the second personal identification token;
confirming, to the first device, a second token, when the first device receives the second personal identification token.

13. The method of claim 12, further comprising:
tracking, via a tracking module of the peer-to-peer management device, the use of the selected item, the tracking comprising recording, within time interval from the time in which the confirmation token was inputted by the second user, the geo-coordinates.

14. The method of claim 13, wherein tracking, via a tracking module of the peer-to-peer management device, the use of the selected item, the tracking further comprises receiving the return data from the first device includes selection condition data, the selection condition data including at least one of a damaged-condition status, a description of the damaged-condition status, a settlement amount, or a photograph file of the item.

15. The method of claim 13, further comprising
calculating an escrow account value, via an escrow account module using an escrow account value algorithm that accounts for the initial condition and data representing the number of times reported to the peer-to-peer management device that the item has been borrowed;
determining, via the escrow account value algorithm, that a value of an escrow account of the second user has reached the replacement threshold for the item and sending an alert to the second device of the second user wherein the alert informs the second user that the value of the escrow account of the second user has reached the replacement threshold; and,
receiving a transfer request from the second user and in response to the request, transferring at least some of the value of the escrow account to a financial account authorized by the second user.

16. The method of claim 15 further comprising sending an alert to the second user informing the second user that the second user escrow account has reached the replacement-with-shipping value;
receiving a request from the second user requesting that the escrow account value be transferred to a third party and that the second user be provided free shipping and a type of shipping speed;
providing an address requesting a price quote plus shipping quote;
confirming that a price quote plus shipping quote does not exceed the value of the escrow account of the second user;
transferring the replacement-with-shipping-value of the second user escrow to a third-party provider;
selecting the shipping speed;
informing the third-party provider to ship the consumer product to the second user;
receiving a shipping confirmation from either the third-party provider or the shipping agent of the third-party provider;
receiving a delivery confirmation; and, reducing the value of the escrow account by the replacement cost and shipping cost.

17. A method for identifying items to acquire a peer-to-peer management device for managing the exchange of the at least one selected item in a peer-to-peer exchange, the method comprising:
accepting, via a potential purchase module of the peer-to-peer management device, the potential purchase module receiving a list user criteria;
identifying a number of attributes of a number of user desired items;
identifying, via a targeted acquisition module, an acquisition item, the acquisition item being an item that meets the list user criteria and the list of user criteria identifying a number of attributes of a number of user desired item; and,
notifying, via an acquisition opportunity module, a shopping user of the acquisition item.

18. The method of claim 17, further comprising:
analyzing, via a tracking module, data from a database of items to identify a value representing the likelihood an item will be exchanged in the future;
comparing, based on the value representing the likelihood an item will be exchanged in the future to identify a scarcity list, the scarcity list being a list of items that are underrepresented in the database.

19. The method of claim 18, further comprising calculating, based on logged search criteria and the scarcity list, an anticipated time to recover purchase costs of an item.

20. The method of claim 17, wherein the item is a tool having a mass greater than 50 grams and configured for constructing activities.
